(19) United States
(12) Patent Application Publication
(10) Pub. No.: US 2019/0278134 A1
(43) Pub. Date: Sep. 12, 2019

(54) BACKLIGHT DEVICE AND DISPLAY APPARATUS INCLUDING SAME

(71) Applicant: SHARP KABUSHIKI KAISHA, Sakai City, Osaka (JP)

(72) Inventors: AYA OKAMOTO, Sakai City (JP); YUHSAKU AJICHI, Sakai City (JP); AKIRA TOMIYOSHI, Sakai City (JP)

(21) Appl. No.: 16/302,933

(22) PCT Filed: Apr. 11, 2017
(86) PCT No.: PCT/JP2017/014765

§ 371 Date: Nov. 19, 2018

(30) Foreign Application Priority Data
May 19, 2016 (JP) 2016-100101

(51) Int. Cl. G02F 1/1335; G09G 3/20; F21V 8/00

(52) U.S. Cl. CPC G02F 1/133603; G09G 3/2003; G02B 6/0055; G02F 1/133526; G02F 1/133606

(57) ABSTRACT

Occurrence of color unevenness and collapsing of white balance is suppressed when a backlight device having a configuration combining a blue LED and a wavelength conversion sheet is adopted.

In a direct backlight device (600) adopting a configuration combining a blue LED (63) and a phosphor sheet (65) to obtain white light, a convex lens (67) as a condenser lens is provided above each blue LED (63) mounted on an LED substrate (62). The convex lens (67) receives light emitted from the blue LED (63) and emits the light to the phosphor sheet (65) side so that an emission angle is smaller than an incident angle.

### TECHNICAL FIELD

The following disclosure relates to a backlight device, and more specifically to a backlight device that obtains white light by a combination of a blue light emitting diode (LED) and a wavelength conversion sheet and a display apparatus including the same.

### BACKGROUND ART

In a liquid crystal display apparatus for displaying a color image, a color is displayed by an additive color mixture of three primary colors. Therefore, in a transmissive liquid crystal display apparatus, a backlight device capable of irradiating a liquid crystal panel with white light including a red component, a green component, and a blue component is required. In the related art, a cold cathode fluorescent tube called a CCFL has been widely adopted as a light source of the backlight device. However, in recent years, adoption of an LED is increasing from viewpoints of lower power consumption and easiness of luminance control. For example, the backlight device having a configuration using a red LED, a green LED, and the blue LED as a light source has been known in the related art.

In recent years, as a technique for realizing widening of color gamut, a technique of obtaining white light by combining the blue LED and a phosphor sheet is gaining attention. The phosphor sheet adopted in the technique functions as a wavelength conversion sheet that converts a wavelength of light emitted from the blue LED so as to obtain white light. In order to realize this, the phosphor sheet contains a phosphor (fluorochrome) that is excited by the light emitted from the blue LED and emits light. Specific examples of the phosphor sheet to be used include a phosphor sheet including a yellow phosphor, or a phosphor sheet including a green phosphor and a red phosphor. There is known a backlight device having a configuration using a white LED (white LED package) with a configuration in which the blue LED is covered with the yellow phosphor as a light source.

FIG. 28 is a side view showing a schematic configuration of a backlight device that obtains white light by a combination of a blue LED and a phosphor sheet (wavelength conversion sheet) in the related art. The backlight device includes a plurality of blue LEDs 93 as a light source, an LED substrate 92 on which the plurality of blue LEDs 93 are mounted, a diffuser plate 94 that diffuses light emitted from the blue LEDs 93 and flatly uniformizes the light, a phosphor sheet 95 that converts a wavelength of the light emitted from the blue LEDs 93 so as to obtain white light, an optical sheet 96 that improves light utilization efficiency, and a chassis that supports the LED substrate 92 and the like. Note that, the chassis is not illustrated in FIG. 28. In the configuration using the blue LED 93 as a light source, the phosphor sheet (for example, phosphor sheet including yellow phosphor) 95 is provided as shown in FIG. 28, so that white light is emitted from the backlight device as backlight light.

The following patent literature is known in relation to the present disclosure. In Japanese Unexamined Patent Application Publication No. 2008-134525, regarding a direct backlight device, a configuration in which a partition that partitions each light region of a light source is provided in order to prevent occurrence of light leakage from one region to another region, interference fringe, color unevenness, and unevenness in luminance is disclosed.

### CITATION LIST

### Patent Literature

PTL 1: Japanese Unexamined Patent Application Publication No. 2008-134525

### SUMMARY OF INVENTION

### Technical Problem

Meanwhile, regarding the liquid crystal display apparatus, reduction of power consumption has been a problem in the related art. In recent years, a liquid crystal display apparatus which performs local dimming processing for controlling luminance (light emission intensity) of the light source for each area where a screen is logically divided into a plurality of areas has been developed. In the local dimming processing, the luminance of the light source is controlled based on an input image in the corresponding area. Specifically, the luminance of each light source is obtained based on a maximum value and an average value of a target luminance (luminance corresponding to input gray scale value) of a pixel included in the corresponding area. In the area where the luminance of the light source is smaller than the original luminance, transmittance of each pixel is increased. Accordingly, the target display luminance can be obtained for each pixel. Furthermore, in recent years, development of HDR drive for displaying an extremely dynamic display range has recently become active. The local dimming processing is also used to realize the HDR drive.

However, when the local dimming processing is performed in the liquid crystal display apparatus including the backlight device having the configuration (FIG. 28) using the phosphor sheet in the related art, only the light sources (blue LEDs 93) of some areas are lighted up (hereinafter, referred to as “partial lighting”), and this may result the occurrence of color unevenness and collapsing of a white balance. This will be described below. Note that, the area where the light source is lighted up is referred to as a “lighting area”, and the area where the light source is lighted off is referred to as a “non-lighting area”.

FIGS. 29 and 30 respectively show chromaticity x and chromaticity y when full lighting is performed in the configuration using the phosphor sheet in the related art. FIGS. 31 and 32 respectively show the chromaticity x and the chromaticity y when lighting (partial lighting) of central 4 areas (vertical 2 areas×horizontal 2 areas) is performed in the configuration using the phosphor sheet in the related art. FIGS. 33 and 34 respectively show the chromaticity x and the chromaticity y when lighting (partial lighting) of central 36 areas (vertical 6 areas×horizontal 6 areas) is performed in the configuration using the phosphor sheet in the related art. In the examples shown in FIGS. 29 to 34, the entire screen is divided into 200 areas (vertical 10 areas×horizontal 20 areas), and FIGS. 29 to 34 respectively show chromaticity distribution of the entire screen.

As shown in FIGS. 29 and 30, the chromaticity x and the chromaticity y are uniform over the entire screen when the full lighting is performed. Specifically, the color of backlight light is white over the entire screen. On the other hand, as can be seen from FIGS. 31 to 34, the chromaticity x and the chromaticity y are different depending on locations when the partial lighting is performed. That is, the color of the backlight light differs depending on locations. For example, the color of the backlight light is close to blue in the portion denoted by an arrow 97 in FIGS. 31 and 32, and the color of the backlight light is close to yellow in the portion denoted by an arrow 98 in FIGS. 31 and 32. Thus, the color of the backlight light has a blue tinge in the vicinity of directly above the blue LED which is lighted up, and the color of the backlight light has a yellower tinge as the distance from the lighting portion increases. It is understood that the backlight light reaches the non-lighting area from FIGS. 31 to 34. As described above, when the partial lighting is performed in the configuration using the phosphor sheet in the related art, the color of the backlight light differs depending on locations, and the backlight light reaches the non-lighting area. As a result, the color unevenness occurs. When comparing FIGS. 31 and 32 and FIGS. 33 and 34, it is understood that the wider the range in which the partial lighting is performed, more gradual the change in the chromaticity. That is, the way in which color unevenness occurs differs depending on the range in which the partial lighting is performed.

As described above, when the partial lighting is performed, the color of the backlight light has a blue tinge in the vicinity of directly above the blue LED which is lighted up. When the partial lighting is performed within a particularly narrow range, the lighting area is irradiated with light having a blue tinge despite the fact that the lighting area should be irradiated originally with white light emitted as the backlight light. In this way, the white balance collapses.

Here, with reference to FIG. 35, the cause of the occurrence of the color unevenness and the collapsing of the white balance when the partial lighting is performed in the configuration using the phosphor sheet in the related art will be explained. Light 9a emitted from the blue LED 93 passes through a phosphor sheet 95, and is divided into light (component) 9b passing through the optical sheet 96 and light (component) 9c reflected by the optical sheet 96. That is, some components of the light 9a emitted from the blue LED 93 are reflected by the optical sheet 96 and returns to the LED substrate 92 side. Since a reflection sheet that generally reflects the light is attached to a surface of the LED substrate 92, the light 9c reflected by the optical sheet 96 is further reflected by the LED substrate 92. The reflected light 9d passes through the phosphor sheet 95, and is divided into light 9e passing through the optical sheet 96 and light 9f reflected by the optical sheet 96. Similarly, the light 9f reflected by the optical sheet 96 is reflected by the LED substrate 92, and light 9g reflected by the LED substrate 92 is divided into light 9h passing through the optical sheet 96 and light 9i reflected by the optical sheet 96. As described above, when the reflection of light is repeated, the color of the light has a yellower tinge every time it passes through the phosphor sheet 95. Therefore, focusing on the light emitted from one blue LED 93, the color of the light has a yellower tinge as the region separates farther from the blue LED 93. In the example shown in FIG. 35, the color of the light 9e has a yellower tinge than the color of the light 9b, and the color of the light 9h has a further yellower tinge than the color of the light 9e.

As described above, the light emitted from one blue LED 93 reaches a surrounding region by repeating the reflection. In other words, some regions are not only irradiated with the light emitted from the blue LED 93 corresponding to the region, but also with the light of the reflection component of the light emitted from the blue LED 93 corresponding to surrounding region. In consideration of these points, the content (phosphor concentration) of phosphor in the phosphor sheet 95 is adjusted so that the backlight light becomes white light when the full lighting is performed.

However, when the partial lighting is performed, the amount of light having a yellow tinge arriving from other areas to the lighting area is smaller than when the full lighting is performed. As a result, the color of the backlight light appearing in the lighting area has a blue tinge and the white balance collapses. This becomes conspicuous as the range in which the partial lighting is performed is narrow. Since the light emitted from the blue LED 93 reaches the surrounding region by repeating the reflection, the non-lighting area is irradiated with light when the partial lighting is performed. At that time, the color of light gradually has a yellower tinge as the distance from the lighting area increases, so the color unevenness occurs.

Therefore, in order to prevent the leakage of light from each area to another area, it is conceivable to provide a partition between areas as disclosed, for example, in Japanese Unexamined Patent Application Publication No. 2008-134525. That is, as shown in FIG. 36, it is conceivable to provide a partition 99 between the LED substrate 92 and the diffuser plate 94 so as to surround the blue LED 93 in each area in the configuration shown in FIG. 28.

However, according to the configuration provided with the partition 99, for example, a shadow of the partition 99 is generated in a portion denoted by reference numeral 990 in FIG. 36, and the unevenness in luminance due to the influence of the shadow occurs sometimes. Moreover, since it is necessary to prepare the partition 99 according to the number of areas and the size of the area, this configuration lacks versatility.

Therefore, an object of the following disclosure is to suppress the occurrence of the color unevenness and the collapsing of the white balance when adopting the backlight device having a configuration combining a blue LED and a wavelength conversion sheet.

### Solution to Problem

According to a first aspect of the present disclosure, there is provided a backlight device of a direct type, including: a light source substrate on which a blue light emitting element that emits blue light is mounted; a wavelength conversion sheet that converts a wavelength of the light emitted from the blue light emitting element; and an optical member that is provided on the light source substrate side from the wavelength conversion sheet, receives the light emitted from the blue light emitting element, and emits the light to the wavelength conversion sheet side so that an emission angle is smaller than an incident angle.

According to a second aspect of the present disclosure, in the first aspect of the present disclosure, the optical member changes a progressing direction of the light emitted from the blue light emitting element in a direction perpendicular to the light source substrate.

According to a third aspect of the present disclosure, in the first aspect of the present disclosure, the optical member is a condenser lens.

According to a fourth aspect of the present disclosure, in the third aspect of the present disclosure, the condenser lens is a convex lens.

According to a fifth aspect of the present disclosure, in the third aspect of the present disclosure, the condenser lens is a Fresnel lens.

According to a sixth aspect of the present disclosure, in the third aspect of the present disclosure, the optical member has a structure that a plurality of blue light emitting elements and a plurality of condenser lenses are integrated in a one-to-one correspondence.

According to a seventh aspect of the present disclosure, in the first aspect of the present disclosure, the optical member is a prism.

According to an eighth aspect of the present disclosure, in the first aspect of the present disclosure, the optical member is a prism sheet in which a plurality of prism rows are formed.

According to a ninth aspect of the present disclosure, in the eighth aspect of the present disclosure, as the prism sheet, at least a first prism sheet and a second prism sheet in which a plurality of prism rows orthogonal to a plurality of prism rows formed in the first prism sheet are formed, are provided.

According to a tenth aspect of the present disclosure, in the eighth aspect of the present disclosure, the backlight device further includes a diffuser plate that is provided on the light source substrate side from the wavelength conversion sheet, and diffuses the light emitted from the blue light emitting element, in which the prism sheet is provided between the blue light emitting element and the diffuser plate.

According to an eleventh aspect of the present disclosure, in the eighth aspect of the present disclosure, the backlight device further includes a diffuser plate that is provided on the light source substrate side from the wavelength conversion sheet, and diffuses the light emitted from the blue light emitting element, in which the prism sheet is provided between the diffuser plate and the wavelength conversion sheet.

According to a twelfth aspect of the present disclosure, in the first aspect of the present disclosure, the optical member is a light guide plate in which reflection materials having surfaces perpendicular to the light source substrate are provided at equal intervals.

According to a thirteenth aspect of the present disclosure, there is provided a display apparatus including: a display panel that includes a display unit which displays an image; the backlight device according to the first aspect of the present disclosure that is disposed so as to irradiate a back surface of the display panel with light; and a light source control unit that controls light emission intensity of the blue light emitting element.

According to a fourteenth aspect of the present disclosure, in the thirteenth aspect of the present disclosure, the display unit is logically divided into a plurality of areas, one or a plurality of blue light emitting elements are associated with each area, and the light source control unit controls the light emission intensity of the blue light emitting element for each area.

According to a fifteenth aspect of the present disclosure, in the fourteenth aspect of the present disclosure, the light emitted from the blue light emitting element associated with each area is applied up to next neighboring area through the optical member.

### Advantageous Effects of Invention

According to the first aspect of the present disclosure, in the backlight device having a configuration combining the blue light emitting element and the wavelength conversion sheet, the optical member that receives the light emitted from the blue light emitting element and emits the light to the wavelength conversion sheet side so that an emission angle is smaller than an incident angle is provided. Therefore, the light progressing from the light source substrate side to the wavelength conversion sheet side becomes light having directivity. Accordingly, it is possible to suppress the light emitted from the blue light emitting element in a certain region from reaching surrounding region. Therefore, when full lighting is performed, the entire screen is irradiated with the backlight light having uniform chromaticity, and when partial lighting is performed, the backlight light having uniform chromaticity is applied within the lighting range. As a result, the occurrence of color unevenness and collapsing of white balance is suppressed. Unlike the configuration in which the partition is provided around the blue light emitting element, unevenness in luminance due to the influence of the shadow of the partition does not occur.

According to the second aspect of the present disclosure, since parallel light is emitted from the optical member, mixing of light from the plurality of blue light emitting elements is effectively suppressed. Therefore, the occurrence of color unevenness and collapsing of white balance can be effectively suppressed.

According to the third aspect of the present disclosure, since it is sufficient to prepare the condenser lens which is relatively easy to obtain, it is possible to realize the backlight device capable of suppressing the occurrence of color unevenness and collapsing of white balance at low cost.

According to the fourth aspect of the present disclosure, the same effect as the third aspect of the present disclosure can be obtained.

According to the fifth aspect of the present disclosure, it is possible to reduce the thickness and weight of the backlight device.

According to the sixth aspect of the present disclosure, it is easy to attach the optical member to the backlight device.

According to the seventh aspect of the present disclosure, the same effect as the first aspect of the present disclosure can be obtained.

According to the eighth aspect of the present disclosure, the same effect as the first aspect of the present disclosure can be obtained.

According to the ninth aspect of the present disclosure, light spreading in directions orthogonal to each other is suppressed by the two prism sheets. Therefore, it is possible to effectively suppress the light emitted from the blue light emitting element in a certain region from reaching surrounding region, and the occurrence of color unevenness and collapsing of white balance can be effectively suppressed.

According to the tenth aspect of the present disclosure, the same effect as the eighth aspect of the present disclosure can be obtained.

According to the eleventh aspect of the present disclosure, the same effect as the eighth aspect of the present disclosure can be obtained.

According to the twelfth aspect of the present disclosure, the same effect as the first aspect of the present disclosure can be obtained.

According to the thirteenth aspect of the present disclosure, in the display apparatus adopting the backlight device having a configuration combining the blue light emitting element and the wavelength conversion sheet, the occurrence of color unevenness and collapsing of white balance is suppressed.

According to the fourteenth aspect of the present disclosure, since the light emission intensity of the light source (blue light emitting element) can be independently controlled, low power consumption can be achieved. Moreover, it is possible to expand the dynamic range by causing the light source to emit light intensively at a high gray scale portion with high light emission intensity.

According to the fifteenth aspect of the present disclosure, light emitted from the blue light emitting element is mixed between adjacent areas. Therefore, the occurrence of display unevenness due to variations in the light source (blue light emitting element) is suppressed.

### BRIEF DESCRIPTION OF DRAWINGS

FIG. 1 is a block diagram showing an overall configuration of a liquid crystal display apparatus including a backlight device according to a first embodiment of the present disclosure.

FIG. 2 is a perspective view of a liquid crystal panel and the backlight device in the first embodiment.

FIG. 3 is a side view of the liquid crystal panel and the backlight device in the first embodiment.

FIG. 4 is a diagram showing another example of a configuration of a condenser lens (convex lens) in the first embodiment.

FIG. 5 is a diagram for explaining areas in the first embodiment.

FIG. 6 is a diagram showing an arrangement state of blue LEDs on an LED substrate in the first embodiment.

FIG. 7 is a flowchart showing an example of a procedure of local dimming processing in the first embodiment.

FIG. 8 is a diagram for explaining control of light emission luminance by the local dimming processing in the first embodiment.

FIG. 9 is a schematic diagram showing a configuration of a unit drive unit for driving blue LEDs included in one LED unit in the first embodiment.

FIG. 10 is a perspective view showing the convex lens for four areas and the LED substrate corresponding thereto in the first embodiment.

FIG. 11 is a diagram showing the convex lens only for one area in FIG. 10.

FIG. 12 is a diagram for explaining progression of light through a biconvex lens.

FIG. 13 is a diagram for explaining the progression of light through a plano-convex lens.

FIG. 14 is a diagram for explaining the progression of light emitted from the blue LED in the first embodiment.

FIG. 15 is a diagram for explaining progression of light emitted from the blue LED in a first modification example of the first embodiment.

FIG. 16 is a diagram for explaining a shape of a Fresnel lens in a second modification example of the first embodiment.

FIG. 17 is a diagram for explaining progression of light emitted from the blue LED in the second modification example of the first embodiment.

FIG. 18 is a diagram showing a configuration example in which a plurality of convex lenses corresponding to each area are integrated with respect to a third modification example of the first embodiment.

FIG. 19 is a diagram showing a configuration in which individual convex lenses are independent with respect to the third modification example of the first embodiment.

FIG. 20 is a side view of a liquid crystal panel and a backlight device according to a second embodiment of the present disclosure.

FIG. 21 is a perspective view of the backlight device in the second embodiment.

FIG. 22 is a diagram for explaining progression of light emitted from a blue LED in the second embodiment.

FIG. 23 is a perspective view of a backlight device in a first modification example of the second embodiment.

FIG. 24 is a perspective view of a backlight device in a second modification example of the second embodiment.

FIG. 25 is a side view of a liquid crystal panel and a backlight device according to a third modification example of the second embodiment.

FIG. 26 is a side view of a liquid crystal panel and a backlight device according to a third embodiment of the present disclosure.

FIG. 27 is a diagram for explaining progression of light emitted from a blue LED in the third embodiment.

FIG. 28 is a side view showing a schematic configuration of a backlight device that obtains white light by a combination of a blue LED and a wavelength conversion sheet in the related art.

FIG. 29 shows chromaticity x when full lighting is performed with a configuration using a phosphor sheet in the related art.

FIG. 30 shows chromaticity y when full lighting is performed in the configuration using the phosphor sheet in the related art.

FIG. 31 shows the chromaticity x when the lighting (partial lighting) of central 4 areas (vertical 2 areas×horizontal 2 areas) is performed in the configuration using the phosphor sheet in the related art.

FIG. 32 shows the chromaticity y when the lighting (partial lighting) of central 4 areas (vertical 2 areas×horizontal 2 areas) is performed in the configuration using the phosphor sheet in the related art.

FIG. 33 shows the chromaticity x when the lighting (partial lighting) of central 36 areas (vertical 6 areas×horizontal 6 areas) is performed in the configuration using the phosphor sheet in the related art.

FIG. 34 shows the chromaticity y when the lighting (partial lighting) of central 36 areas (vertical 6 areas×horizontal 6 areas) is performed in the configuration using the phosphor sheet in the related art.

FIG. 35 is a diagram for explaining the reason why color unevenness and collapsing of white balance occur when the partial lighting is performed in the configuration using the phosphor sheet in the related art.

FIG. 36 shows a configuration in which partitions are provided so as to surround the blue LED in each area.

### DESCRIPTION OF EMBODIMENTS

Hereinafter, embodiments of the present disclosure will be described with reference to the accompanying drawings.

### 1. First Embodiment

### 1.1 Overall Configuration and Operation Outline

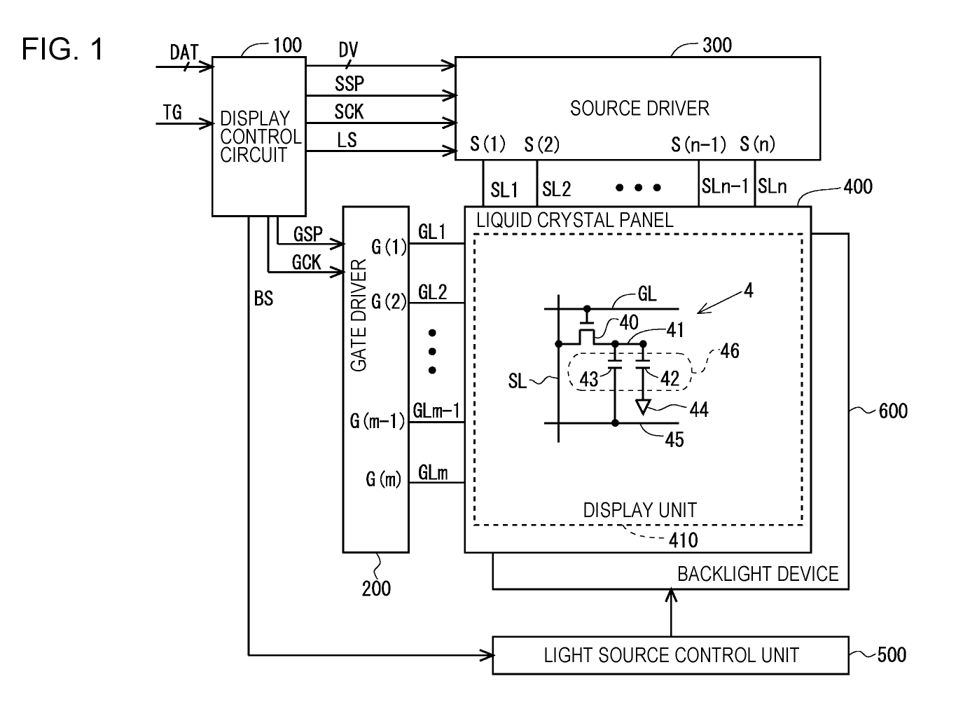

FIG. 1 is a block diagram showing an overall configuration of a liquid crystal display apparatus including a backlight device 600 according to a first embodiment of the present disclosure. The liquid crystal display apparatus includes a display control circuit 100, a gate driver (scanning signal line drive circuit) 200, a source driver (video signal line drive circuit) 300, a liquid crystal panel 400, a light source control unit 500, and the backlight device 600. The liquid crystal panel 400 includes a display unit 410 that displays an image. The gate driver 200 or the source driver 300, or both may be provided in the liquid crystal panel 400.

Regarding FIG. 1, a plurality (n) of source bus lines (video signal lines) SL1 to SLn and a plurality (m) of gate bus lines (scanning signal lines) GL1 to GLm are arranged in the display unit 410. A pixel formation unit 4 that forms a pixel is provided corresponding to respective intersections of the source bus lines SL 1 to SLn and the gate bus lines GL 1 to GLm. That is, the display unit 410 includes a plurality (m×n) of pixel formation units 4. The plurality of pixel formation units 4 are arranged in a matrix and form a pixel matrix. Each of the pixel formation unit 4 includes a thin film transistor (TFT) 40 which is a switching element having a gate terminal connected to a gate bus line GL passing through a corresponding intersection and a source terminal connected to a source bus line SL passing through the corresponding intersection, a pixel electrode 41 connected to a drain terminal of the TFT 40, a common electrode 44 and an auxiliary capacity electrode 45 commonly provided for the plurality of pixel formation units 4, a liquid crystal capacity 42 formed by the pixel electrode 41 and the common electrode 44, and an auxiliary capacity 43 formed by the pixel electrode 41 and the auxiliary capacity electrode 45. A pixel capacity 46 includes the liquid crystal capacity 42 and the auxiliary capacity 43. In the display unit 410 in FIG. 1, only the components corresponding to one pixel formation unit 4 are shown.

Meanwhile, as the TFT 40 in the display unit 410, for example, an oxide TFT (a thin film transistor using an oxide semiconductor for a channel layer) can be adopted. More specifically, a TFT in which a channel layer is formed of In—Ga—Zn—O (indium gallium zinc oxide) which is an oxide semiconductor containing indium (In), gallium (Ga), zinc (Zn), and oxygen (O) as main components (hereinafter referred to as “In—Ga—Zn—O-TFT”) can be adopted as the TFT 40. Adoption of such an In—Ga—Zn—O-TFT provides effects such as high definition and low power consumption. Alternatively, a transistor using an oxide semiconductor other than In—Ga—Zn—O (indium gallium zinc oxide) as a channel layer can be adopted. For example, the same effect can be obtained also in a case where a transistor using an oxide semiconductor including at least one of indium, gallium, zinc, copper (Cu), silicon (Si), tin (Sn), aluminum (Al), calcium (Ca), germanium (Ge), and lead (Pb) as a channel layer is adopted. Note that, the present disclosure does not exclude the use of TFTs other than oxide TFTs.

Next, the operation of the components shown in FIG. 1 will be described. The display control circuit 100 receives an image signal DAT and a timing signal group TG such as a horizontal synchronization signal and a vertical synchronization signal sent from an outside, and outputs a digital video signal DV, a gate start pulse signal GSP and a gate clock signal GCK for controlling the operation of the gate driver 200, a source start pulse signal SSP, a source clock signal SCK, and a latch strobe signal LS for controlling the operation of the source driver 300, and a light source control signal BS for controlling the operation of the light source control unit 500.

The gate driver 200 repeats applying active scanning signals G(1) to G(m) to each of the gate bus lines GL1 to GLm with one vertical scanning period as a cycle based on the gate start pulse signal GSP and the gate clock signal GCK sent from the display control circuit 100.

The source driver 300 receives the digital video signal DV, the source start pulse signal SSP, the source clock signal SCK, and the latch strobe signal LS sent from the display control circuit 100, and applies the driving video signals S(1) to S(n) to the source bus lines SL1 to SLn. At this time, in the source driver 300, the digital video signal DV indicating the voltage to be applied to each of the source bus lines SL1 to SLn is sequentially held at the timing when the pulse of the source clock signal SCK is generated. Then, at the timing when the pulse of the latch strobe signal LS is generated, the held digital video signal DV is converted into an analog voltage. The converted analog voltage is simultaneously applied to all the source bus lines SL1 to SLn as the driving video signals S(1) to S(n).

The light source control unit 500 controls the luminance (light emission intensity) of the light source in the backlight device 600 based on the light source control signal BS sent from the display control circuit 100. Accordingly, the backlight device 600 irradiates the back surface of the liquid crystal panel 400 with backlight light. In the present embodiment, local dimming processing is performed, which will be described later.

As described above, the scanning signals G(1) to G(m) are applied to the gate bus lines GL1 to GLm, the driving video signals S(1) to S(n) are applied to the source bus lines SL1 to SLn, and the luminance of the light source in the backlight device 600 is controlled, whereby an image corresponding to the image signal DAT sent from the outside is displayed on the display unit 410.

### 1.2 Outline of Backlight Device

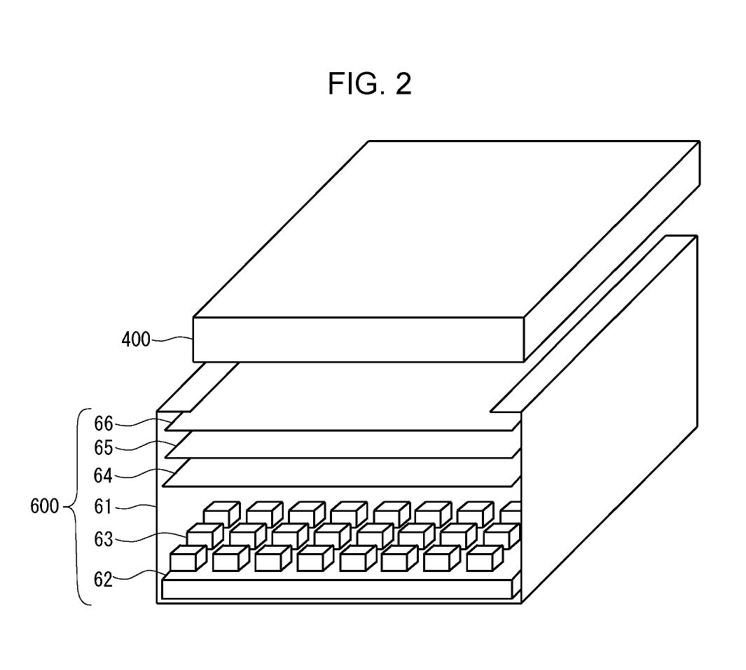

FIG. 2 is a perspective view of the liquid crystal panel 400 and the backlight device 600. FIG. 3 is a side view of the liquid crystal panel 400 and the backlight device 600. In FIG. 2, the illustration of a convex lens (condenser lens) to be described later is omitted. The backlight device 600 is provided on the back surface of the liquid crystal panel 400. That is, the backlight device 600 in the present embodiment is a direct backlight device.

The backlight device 600 includes a chassis 61, an LED substrate 62, a plurality of the blue LEDs 63, a diffuser plate 64, a phosphor sheet 65, an optical sheet 66, and a convex lens 67 as a condenser lens. The chassis 61 supports the LED substrate 62 and the like. The LED substrate 62 is, for example, a metal substrate and mounts the plurality of blue LEDs 63. A reflection sheet 621 is attached to the surface of the LED substrate 62 in order to enhance the utilization efficiency of the light emitted from the blue LED 63. The blue LED 63 is a light source of the backlight device 600, and emits blue light. The convex lens 67 is disposed above each blue LED 63. The convex lens 67 changes a progressing direction of the light emitted from the blue LED 63 in a direction perpendicular to the LED substrate 62. In the present embodiment, an optical member that receives the light emitted from a blue light emitting element (blue LED 63) and emits the light to the wavelength conversion sheet (phosphor sheet 65) side so that an emission angle becomes smaller than the incident angle is realized by the convex lens 67. The diffuser plate 64 is disposed above the convex lens 67. The diffuser plate 64 diffuses the light emitted from the blue LED 63 so that the backlight light becomes planarly uniform light. The phosphor sheet 65 is disposed above the diffuser plate 64. The phosphor sheet 65 converts the wavelength of the light emitted from the blue LED 63 so that the backlight light emitted from the backlight device 600 becomes white light. In order to realize this, the phosphor sheet 65 is provided with a yellow phosphor (alternatively, green phosphor emitting green light and red phosphor emitting red light) excited by light emitted from the blue LED 63 to emit yellow light. The optical sheet 66 is disposed above the phosphor sheet 65. Generally, the optical sheet 66 is composed of a plurality of sheets. Each of the plurality of sheets has a function of diffusing light, a condensing function, a function of enhancing light utilization efficiency, and the like.

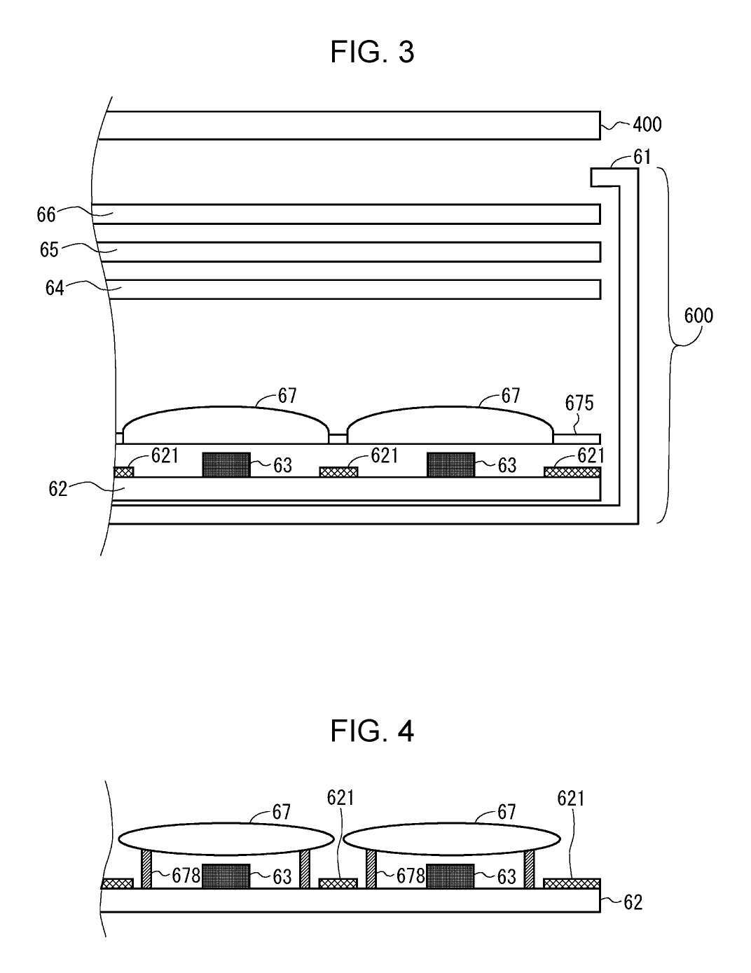

In the present embodiment, a plurality of the convex lenses 67 are integrated by a single lens substrate 675. However, the present disclosure is not limited thereto, and as shown in FIG. 4, a configuration in which individual convex lenses 67 are independent can be adopted. In that case, the convex lens 67 is fixed on the LED substrate 62 by providing, for example, legs 678. A more detailed description of the convex lens 67 as a condenser lens will be given later.

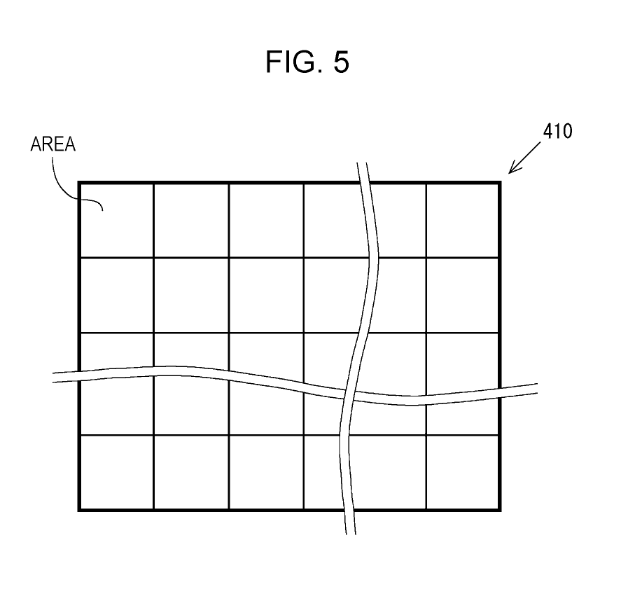

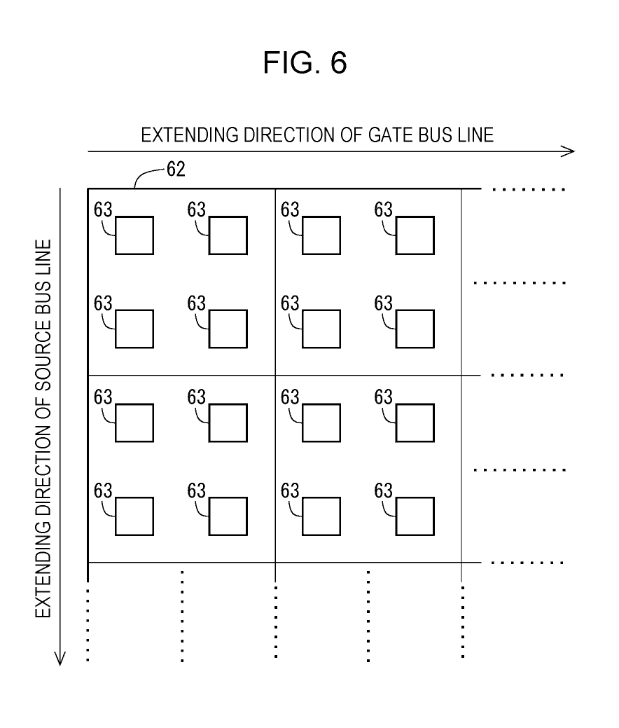

In the present embodiment, the display unit 410 for displaying an image is logically (not physically) divided into a plurality of areas (area to be the smallest unit for controlling light source) as shown in FIG. 5 in order to perform the local dimming processing to be described later. The blue LED 63 is provided so as to correspond to each area on the LED substrate 62. FIG. 6 is a diagram showing an arrangement state of the blue LEDs 63 on the LED substrates 62. As shown in FIG. 6, in the present embodiment, one organized LED unit (light source unit) is formed by four blue LEDs 63. Such LED units are arranged at equal intervals in a direction in which the gate bus line GL extends and are also arranged at equal intervals in a direction in which the source bus line SL extends. In this way, the LED unit including four blue LEDs 63 is provided for each area.

### 1.3 Local Dimming Processing and Driving of Backlight Device

In the liquid crystal display apparatus according to the present embodiment, the above-described local dimming processing is performed. That is, the display unit 410 is logically divided into a plurality of areas as shown in FIG. 5, and the luminance (light emission intensity) of the light source (blue LED 63) is controlled for each area.

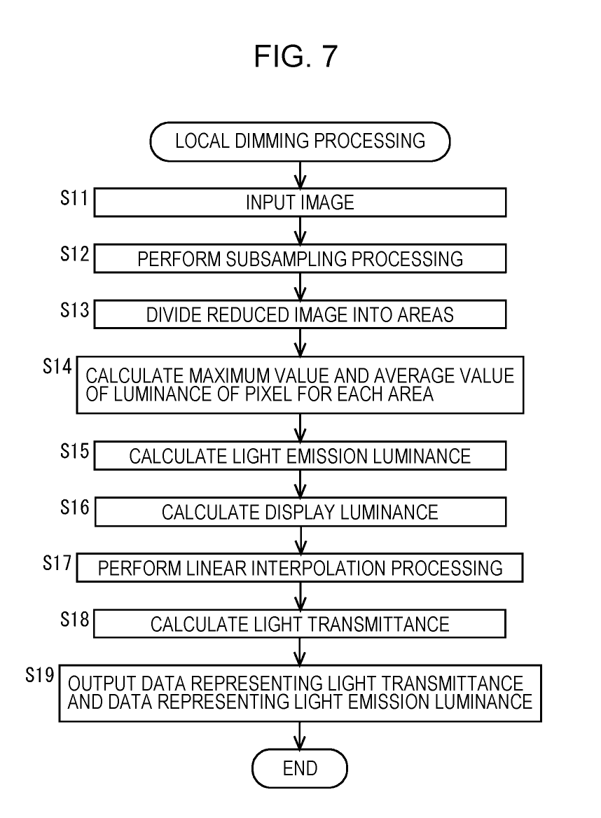

Here, an example of the procedure of the local dimming processing will be described with reference to FIG. 7. The local dimming processing is performed by a local dimming processing unit (not shown) in the display control circuit 100 (see FIG. 1). Here, it is assumed that the display unit 410 is divided into (vertical p×horizontal q) areas.

First, the image signal DAT sent from the outside is input to the local dimming processing unit as input image data (step S11). The input image data includes the luminance (luminance data) of (m×n) pixels. Next, the local dimming processing unit performs subsampling processing (averaging processing) on the input image data to obtain a reduced image including the luminances of (sp×sq) pixels (s is an integer of 2 or more) (Step S12). Next, the local dimming processing unit divides the reduced image into data of (p×q) areas (step S13). The data of each area includes the luminance of (s×s) pixels. Next, for each of the (p×q) areas, the local dimming processing unit obtains a maximum value Ma of the luminances of the pixels in the area and an average value Me of the luminances of the pixels in the area (step S14). Next, based on the maximum value Ma, the average value Me, and the like obtained in step S14, the local dimming processing unit obtains (p×q) light emission luminances of the light source (blue LED 63) corresponding to each area (step S15).

Next, the local dimming processing unit obtains (tp×tq) display luminances (t is an integer of 2 or more) based on (p×q) light emission luminances obtained in step S15 (step S16). Next, the local dimming processing unit obtains backlight luminance data including (m×n) display luminances by performing linear interpolation processing on (tp×tq) display luminances (step S17). The backlight luminance data represents the luminances of light incident on (m×n) pixels when all the light sources (blue LEDs 63) emit light with the light emission luminance obtained in step S15. Next, the local dimming processing unit divides the luminances of (m×n) pixels included in the input image by (m×n) display luminances included in the backlight luminance data, respectively, and obtains light transmittance in (m×n) pixels (step S18). Finally, the local dimming processing unit outputs the digital video signal DV corresponding to the data representing the light transmittance obtained in step S18 and the light source control signal BS for causing the light source (blue LED 63) corresponding to each area to emit light with the light emission luminances obtained in step S15 (step S19).

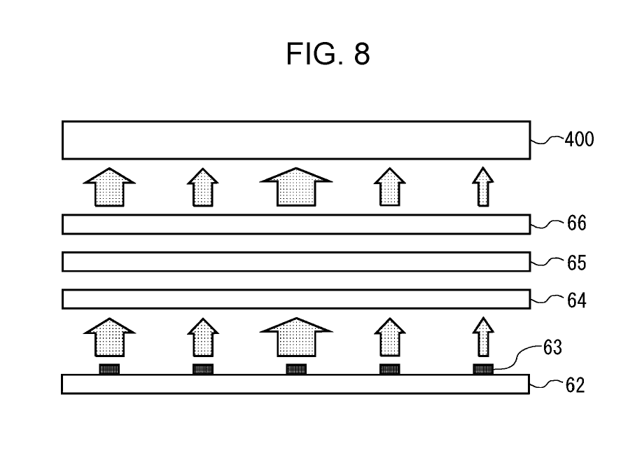

By performing the local dimming processing as described above, light having a luminance (light emission intensity) which is different for each area is emitted as schematically shown in FIG. 8. In FIG. 8, the luminance of the light (light emission intensity) is represented by the thickness of the arrow.

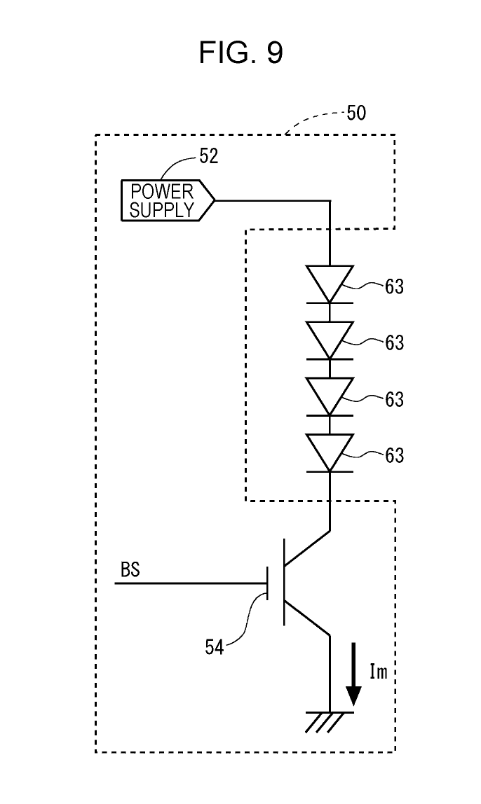

FIG. 9 is a schematic diagram showing a configuration of a unit drive unit 50 for driving the blue LEDs 63 included in one LED unit. As shown in FIG. 9, the unit drive unit 50 includes a power supply 52 and a current control transistor 54. For the current control transistor 54, the light source control signal BS is applied to the gate terminal, the drain terminal is connected to the blue LED 63, and the source terminal is grounded. Four blue LEDs 63 are connected in series between the power supply 52 and the drain terminal of the current control transistor 54. In such a configuration, the light source control signal BS according to the target luminance (light emission intensity) of the blue LED 63 is applied to the gate terminal of the current control transistor 54. Accordingly, a drive current Im corresponding to the target luminance of the blue LED 63 flows.

### 1.4 Condenser Lens (Convex Lens)

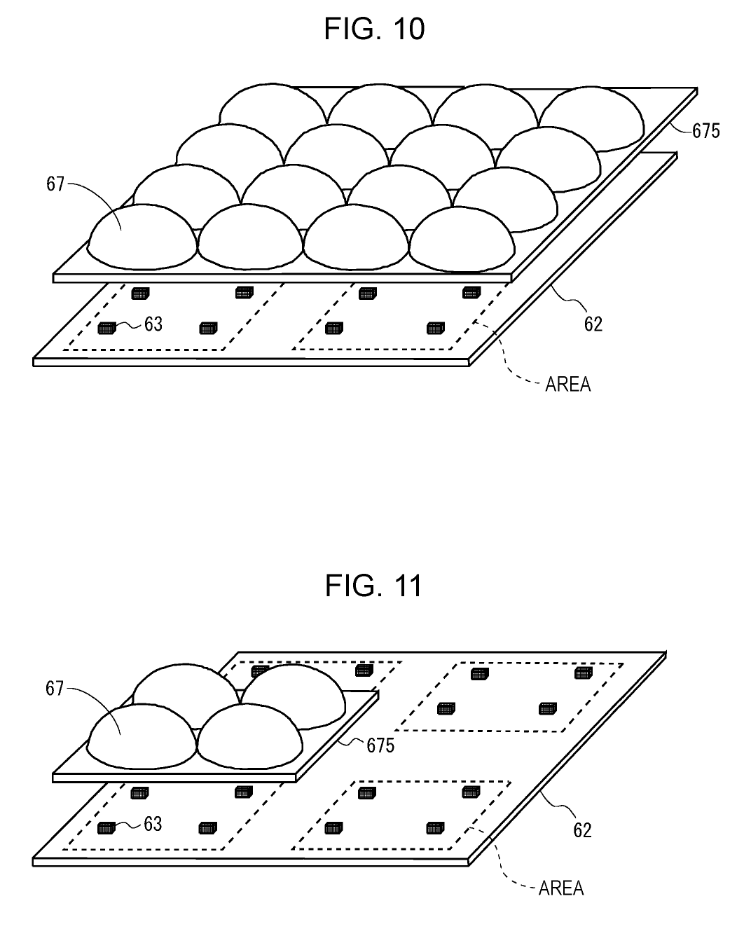

Next, the condenser lens used in the present embodiment for changing the progressing direction of the light emitted from the blue LED 63 will be described in detail. In the present embodiment, as described above, the convex lens 67 is used as a condenser lens. FIG. 10 is a perspective view showing the convex lens 67 for four areas and the LED substrate 62 corresponding thereto. In addition, FIG. 11 is a diagram showing only one area of the convex lens 67 in FIG. 10. As can be seen from FIGS. 10 and 11, the plurality of convex lenses 67 integrated by the lens substrate 675 are disposed so as to correspond to the plurality of blue LEDs 63 provided on the LED substrate 62 in a one-to-one correspondence. In the present embodiment, one organized LED unit is formed by four blue LEDs 63, and such an LED unit is provided for each area. Therefore, four convex lenses 67 are provided for each area.

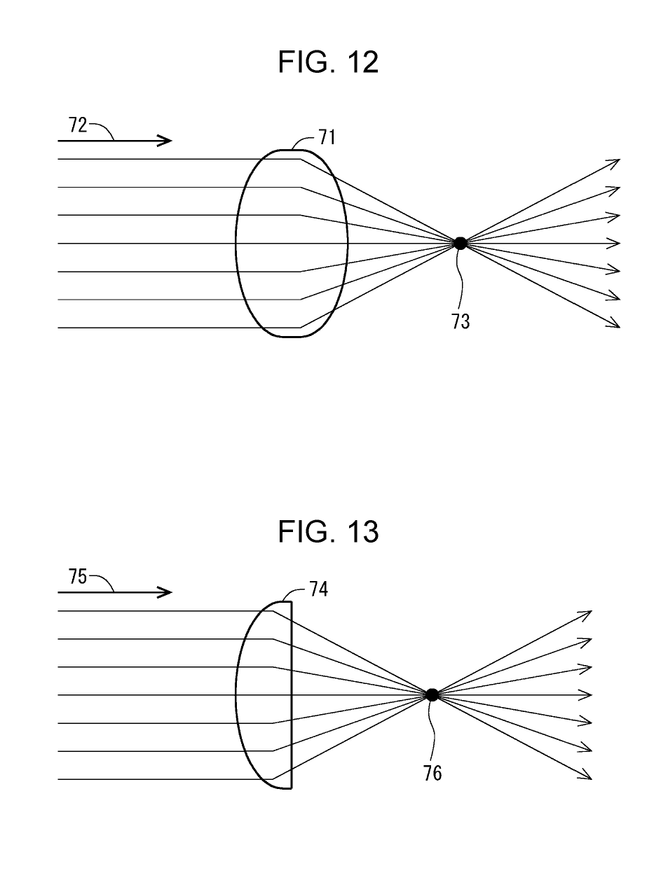

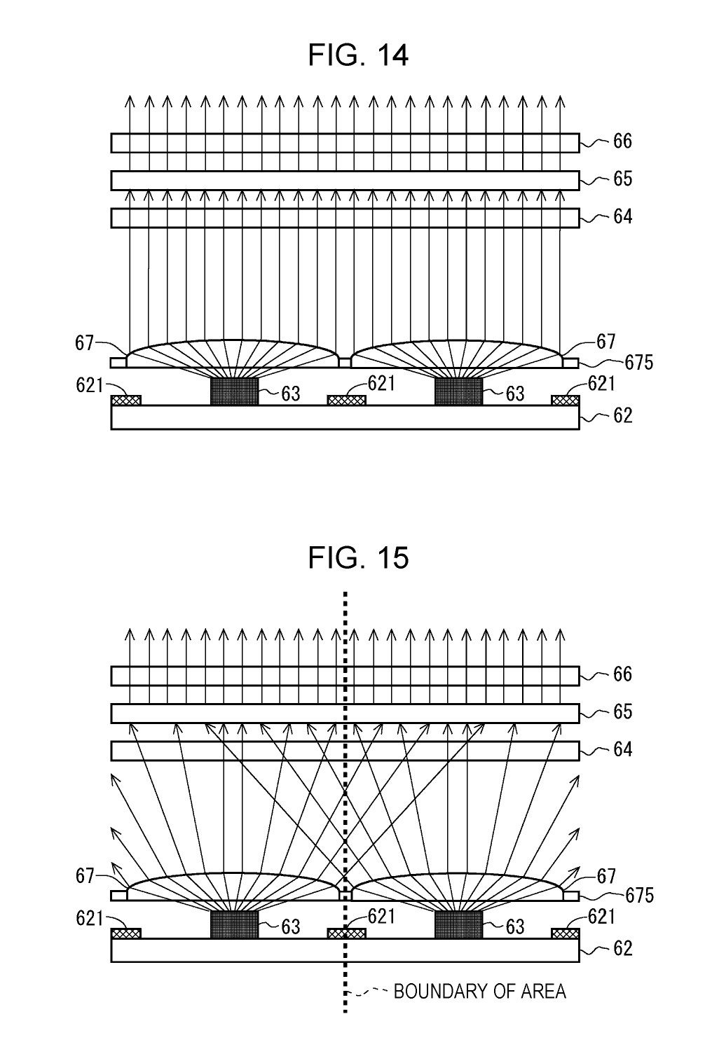

For example, as shown in FIG. 12, when parallel light is applied to a biconvex lens 71 in the direction denoted by an arrow 72, the parallel light passes through the biconvex lens 71 and is focused at the position of a focal point 73. Similarly, as shown FIG. 13, when parallel light is applied to a plano-convex lens 74 in the direction denoted by an arrow 75, the parallel light passes through the plano-convex lens 74 and is focused at the position of a focal point 76. When a light source is disposed at such a focal point and light is applied to the convex lens (biconvex lens 71, plano-convex lens 74) from the direction opposite to the examples shown in FIG. 12 and FIG. 13, parallel light is emitted from the convex lens. Therefore, in the present embodiment, the convex lens 67 is disposed so that the position of the blue LED 63 on the LED substrate 62 becomes the focal position as described above. Accordingly, the light emitted from the blue LED 63 becomes parallel light after passing through the convex lens 67 as shown in FIG. 14 and is applied to the diffuser plate 64. As described above, the convex lens 67 in the present embodiment changes the progressing direction of the light emitted from the blue LED 63 in a direction perpendicular to the LED substrate 62. Therefore, the light emitted from the blue LED 63 in each area hardly reaches other areas.

Since the light emitted from the blue LED 63 in each area does not reach other areas, on the contrary, unlike the case in the related art, each area is not irradiated with the light of the reflection component of the light emitted from other areas. In consideration of this point, the content (phosphor concentration) of the phosphor in the phosphor sheet 65 is adjusted.

### 1.5 Effect

According to the present embodiment, in the backlight device 600 having a configuration combining the blue LED 63 and the phosphor sheet 65, a convex lens 67 as a condenser lens is provided above each blue LED 63. Therefore, the light emitted from the blue LED 63 becomes light having directivity. More specifically, by disposing appropriately designed convex lenses 67 at appropriate positions, the light emitted from the blue LED 63 becomes light perpendicular to the LED substrate 62 and is applied to the phosphor sheet 65. Accordingly, it is possible to suppress the light emitted from the blue LED 63 in each area from reaching other areas. In other words, the light emitted from the blue LED 63 in other areas hardly reaches each area. Therefore, when full lighting is performed, the entire screen is irradiated with the backlight light having uniform chromaticity, and when partial lighting is performed, the backlight light having uniform chromaticity is applied within the lighting range. As a result, the occurrence of color unevenness and collapsing of white balance is suppressed. As described above, according to the present embodiment, in the liquid crystal display apparatus adopting the backlight device 600 having a configuration combining the blue LED 63 and the phosphor sheet 65, the occurrence of color unevenness and collapsing of white balance is suppressed.

As shown in FIG. 36, unlike the configuration provided with the partition 99, the unevenness in luminance due to the influence of the shadow of the partition 99 does not occur. Moreover, it is unnecessary to prepare the partition 99 according to the number of areas and the size of the area, and it is only necessary to prepare a condenser lens (convex lens 67 in the present embodiment) which is relatively easy to obtain. Accordingly, it is possible to realize the backlight device 600 capable of suppressing the occurrence of color unevenness and collapsing of white balance at a low cost.

Furthermore, in the liquid crystal display apparatus according to the present embodiment, the local dimming processing is performed. That is, the light emission intensity of the blue LED 63 is controlled for each area.

Therefore, low power consumption can be achieved. In addition, it is possible to expand the dynamic range by causing the blue LED 63 to emit light intensively at a high gray scale portion with high light emission intensity.

### 1.6 Modification Examples

Hereinafter, modification examples of the first embodiment will be described.

### 1.6.1 First Modification Example

According to the first embodiment, since the light emitted from the blue LEDs 63 in other areas hardly reaches each area, the chromaticity of the backlight light becomes uniform, and the occurrence of color unevenness and collapsing of white balance is suppressed. However, when the light source (blue LED 63) has variations (for example, manufacturing variations), display unevenness due to the variations can occur because the light is hardly mixed between the areas.

Therefore, in the present modification example, a convex lens 67 designed to irradiate up to the next neighboring area with the light emitted from the blue LED 63 in each area is disposed above each blue LED 63. Accordingly, as shown in FIG. 15, the light emitted from the convex lens 67 corresponding to each blue LED 63 is spread to the surroundings. Therefore, light mixes between adjacent areas, and the occurrence of display unevenness due to the variations in the light source (blue LED 63) is suppressed.

In the present modification example, the light emitted from the blue LED 63 in each area is applied up to the next neighboring area, but the present disclosure is not limited thereto. Within a range in which the occurrence of color unevenness caused by the light gradually having a yellower tinge due to repetition of reflection is suppressed, two or more preceding areas may be irradiated with the light emitted from the blue LED 63 in each area.

### 1.6.2 Second Modification Example

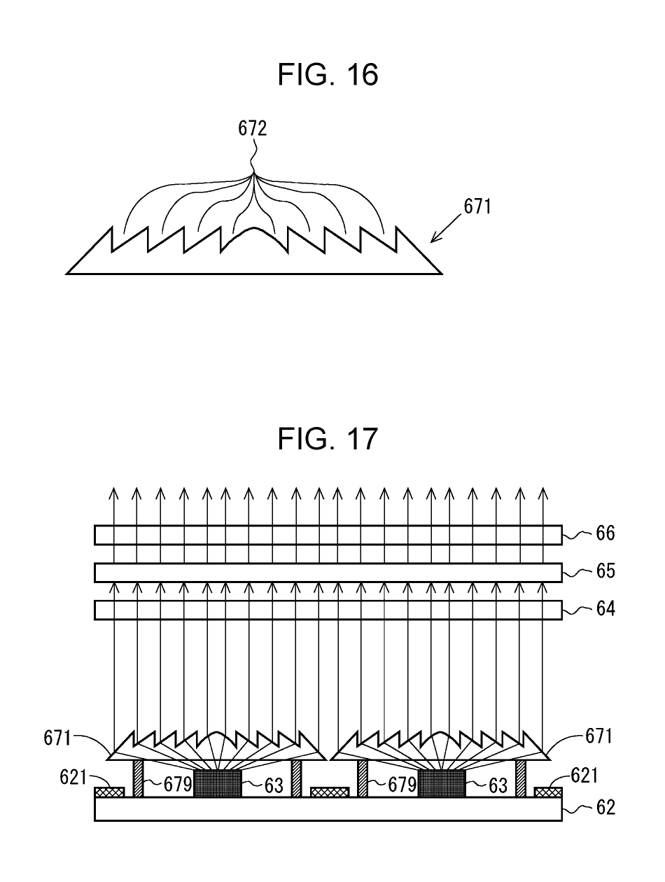

In the first embodiment, the convex lens 67 is adopted as the condenser lens, but the present disclosure is not limited thereto. In the present modification example, a Fresnel lens 671 having a cross section with a shape as shown in FIG. 16 is adopted as a condenser lens. The Fresnel lens 671 is obtained by replacing a curved surface of a general lens with a plurality of concentric groove portions 672. Parallel light can be obtained by placing the light source at the focal point of the Fresnel lens 671.

In the present modification example, the Fresnel lens 671 is disposed so that the position of the blue LED 63 on the LED substrate 62 is at the focal position. Accordingly, as shown in FIG. 17, the light emitted from the blue LED 63 becomes parallel light after passing through the Fresnel lens 671 and is applied to the diffuser plate 64. As described above, the Fresnel lens 671 in the present modification example changes the progressing direction of the light emitted from the blue LED 63 in a direction perpendicular to the LED substrate 62. Therefore, the light emitted from the blue LED 63 in each area hardly reaches other areas. In the example shown in FIG. 17, the Fresnel lens 671 is fixed on the LED substrate 62 by providing, for example, legs 679.

Since the Fresnel lens 671 is a lens thinner than the convex lens 67, according to the present modification example, it is possible to make the backlight device thinner and lighter.

### 1.6.3 Third Modification Example

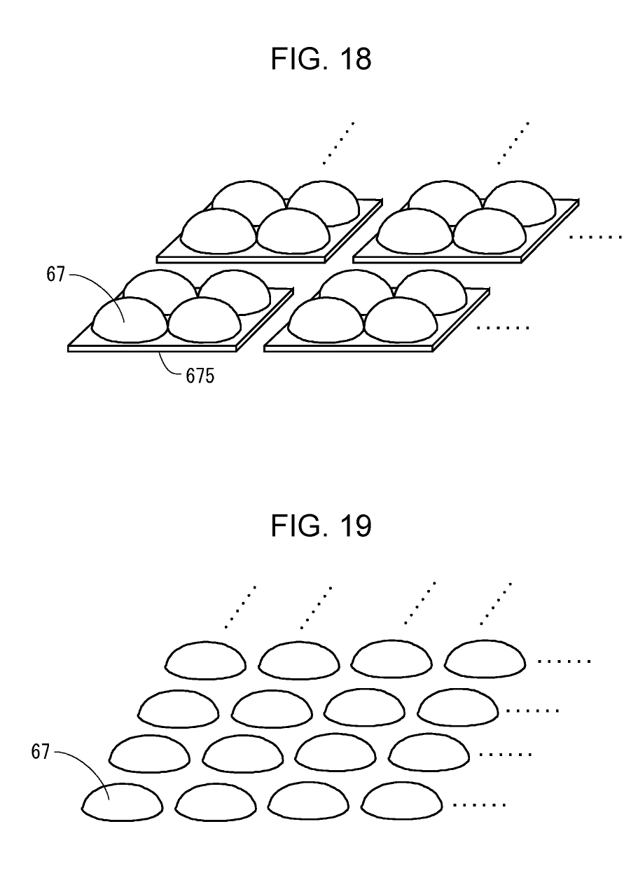

In the first embodiment, as shown in FIG. 10, all the convex lenses 67 are integrated by the lens substrate 675, but the present disclosure is not limited thereto. For example, as shown in FIG. 18, a plurality of corresponding convex lenses 67 may be integrated by the lens substrate 675 for each area. Furthermore, for example, it is also possible to adopt a configuration in which individual convex lenses 67 are independent as shown in FIG. 19 without providing the lens substrate 675 for integrating the plurality of convex lenses 67.

### 2. Second Embodiment

A second embodiment of the present disclosure will be described. In the following description, points different from the first embodiment will be mainly described, and description of points similar to those in the first embodiment will be omitted.

### 2.1 Configuration of Backlight Device

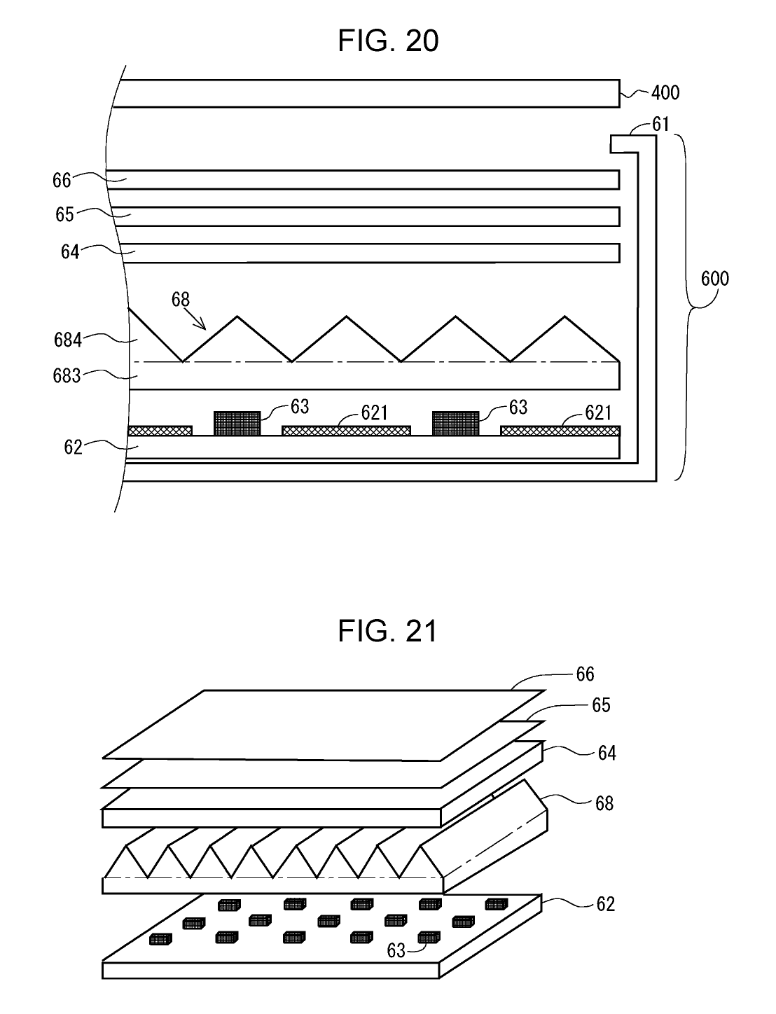

FIG. 20 is a side view of a liquid crystal panel 400 and a backlight device 600 according to the present embodiment. FIG. 21 is a perspective view of the backlight device 600 in the present embodiment. In the present embodiment, the backlight device 600 is provided with a prism sheet 68 in place of the convex lens 67 (see FIG. 3) in the first embodiment. That is, in the present embodiment, an optical member that receives the light emitted from the blue light emitting element (blue LED 63) and emits the light to the wavelength conversion sheet (phosphor sheet 65) side so that the emission angle becomes smaller than the incident angle is realized by the prism sheet 68.

The prism sheet 68 includes a sheet substrate 683 and a plurality of prism rows 684 having a triangular cross section. The prism sheet 68 is disposed above the blue LED 63. Specifically, the prism sheet 68 is disposed between the LED substrate 62 on which the plurality of blue LEDs 63 are mounted and the diffuser plate 64. As can be seen from FIGS. 20 and 21, the sheet substrate 683 faces the LED substrate 62, and the prism row 684 faces the diffuser plate 64.

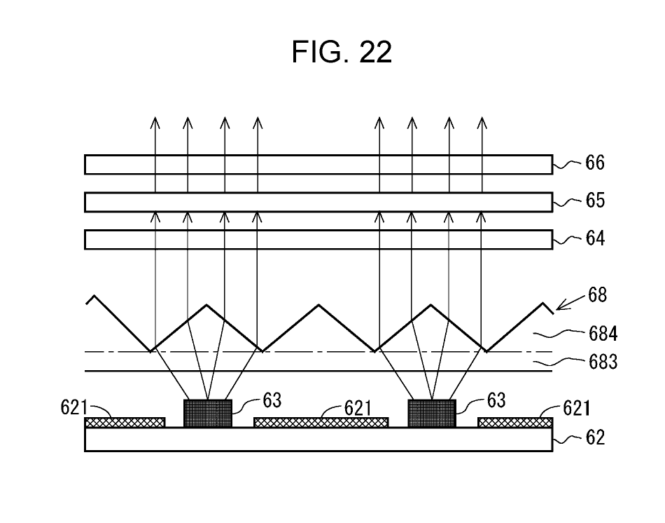

The prism refracts light with a different refractive index depending on the (light) wavelength. Therefore, in the present embodiment, the prism sheet 68 is disposed in consideration of the refractive index of the wavelength of the blue light. Accordingly, the light emitted from the blue LED 63 becomes parallel light after passing through the prism sheet 68 and is applied to the diffuser plate 64 as shown in FIG. 22. As described above, the prism sheet 68 in the present embodiment changes the progressing direction of the light emitted from the blue LED 63 in a direction perpendicular to the LED substrate 62. Therefore, the light emitted from the blue LED 63 in each area hardly reaches other areas.

### 2.2 Effect

In the present embodiment, similarly to the first embodiment, in the liquid crystal display apparatus adopting the backlight device 600 having a configuration combining the blue LED 63 and the phosphor sheet 65, the occurrence of color unevenness and collapsing of white balance is suppressed.

### 2.3 Modification Examples

Hereinafter, modification examples of the second embodiment will be described.

### 2.3.1 First Modification Example

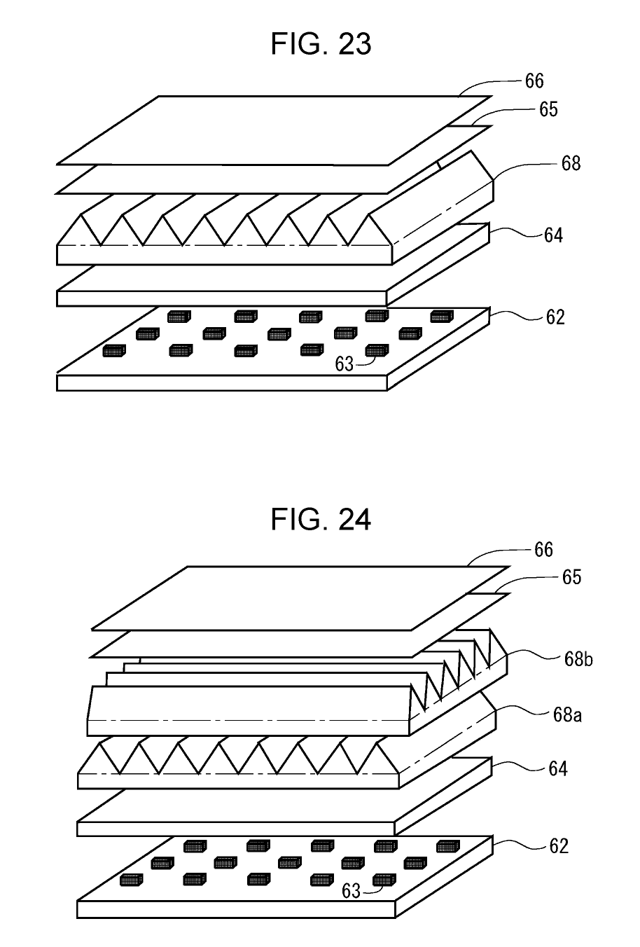

FIG. 23 is a perspective view of a backlight device 600 in a first modification example of the second embodiment. In the second embodiment, the prism sheet 68 is disposed between the LED substrate 62 on which the plurality of blue LEDs 63 are mounted and the diffuser plate 64. On the other hand, in the present modification example, the prism sheet 68 is disposed between the diffuser plate 64 and the phosphor sheet 65 (see FIG. 23).

According to the present modification example, the light emitted from the diffuser plate 64 to the liquid crystal panel 400 side becomes parallel light after passing through the prism sheet 68 and is applied to the phosphor sheet 65. Accordingly, it is possible to suppress the light emitted from the blue LED 63 in each area from reaching other areas.

### 2.3.2 Second Modification Example

FIG. 24 is a perspective view of a backlight device 600 in a second modification example of the second embodiment. In the second embodiment, one prism sheet 68 is provided in the backlight device 600. On the other hand, in the present modification example, the backlight device 600 is provided with two prism sheets 68a and 68b (see FIG. 24). More specifically, the two prism sheets 68a and 68b are provided between the diffuser plate 64 and the phosphor sheet 65. A prism row formed in one prism sheet 68a and a prism row formed in the other prism sheet 68b are orthogonal to each other. It is also possible to adopt a configuration in which two prism sheets are provided between the LED substrate 62 on which the plurality of blue LEDs 63 are mounted and the diffuser plate 64. It is also possible to adopt a configuration in which three or more prism sheets are provided.

According to the present modification example, spreading of light in the direction in which the gate bus line GL extends is suppressed in one of the two prism sheets 68a and 68b, and spreading of light in the direction in which the source bus line SL extends is suppressed in the other of the two prism sheets 68a and 68b. Accordingly, it is possible to effectively suppress the light emitted from the blue LED 63 in each area reaching other areas.

### 2.3.3 Third Modification Example

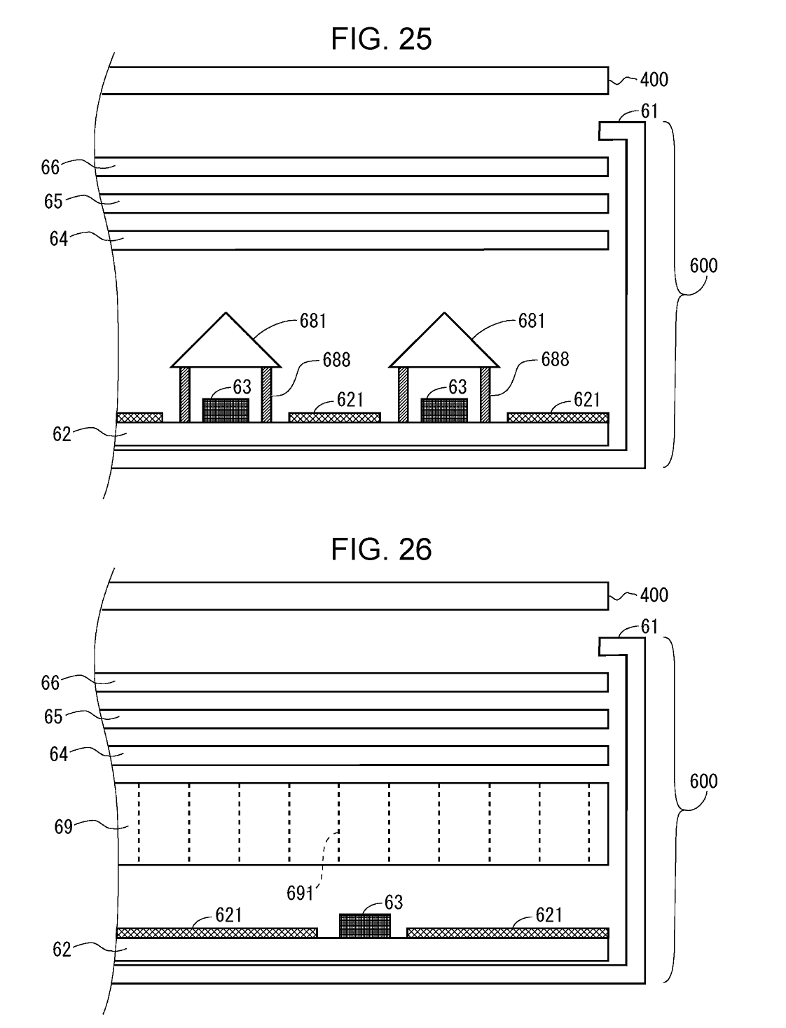

FIG. 25 is a side view of a liquid crystal panel 400 and a backlight device 600 according to the present modification example. In the present modification example, the backlight device 600 is provided with a prism 681 in place of the prism sheet 68 in the second embodiment. More specifically, a plurality of prisms 681 are provided so as to correspond to the plurality of blue LEDs 63 provided on the LED substrate 62 in a one-to-one correspondence. The prism 681 is fixed on the LED substrate 62, for example, by providing legs 688.

According to the present modification example, the light emitted from the blue LED 63 becomes parallel light after passing through the prism 681 and is applied to the diffuser plate 64. Accordingly, it is possible to suppress the light emitted from the blue LED 63 in each area from reaching other areas.

### 3. Third Embodiment

### 3.1 Configuration of Backlight Device

FIG. 26 is a side view of a liquid crystal panel 400 and a backlight device 600 according to the present embodiment. In the present embodiment, the backlight device 600 is provided with a light guide plate 69 in place of the convex lens 67 (see FIG. 3) in the first embodiment. As shown in FIG. 26, on the light guide plate 69, reflection materials 691 having surfaces perpendicular to the LED substrate 62 are provided at equal intervals. In the present embodiment, an optical member that receives the light emitted from the blue light emitting element (blue LED 63) and emits the light to the wavelength conversion sheet (phosphor sheet 65) side so that the emission angle becomes smaller than the incident angle is realized by the light guide plate 69.

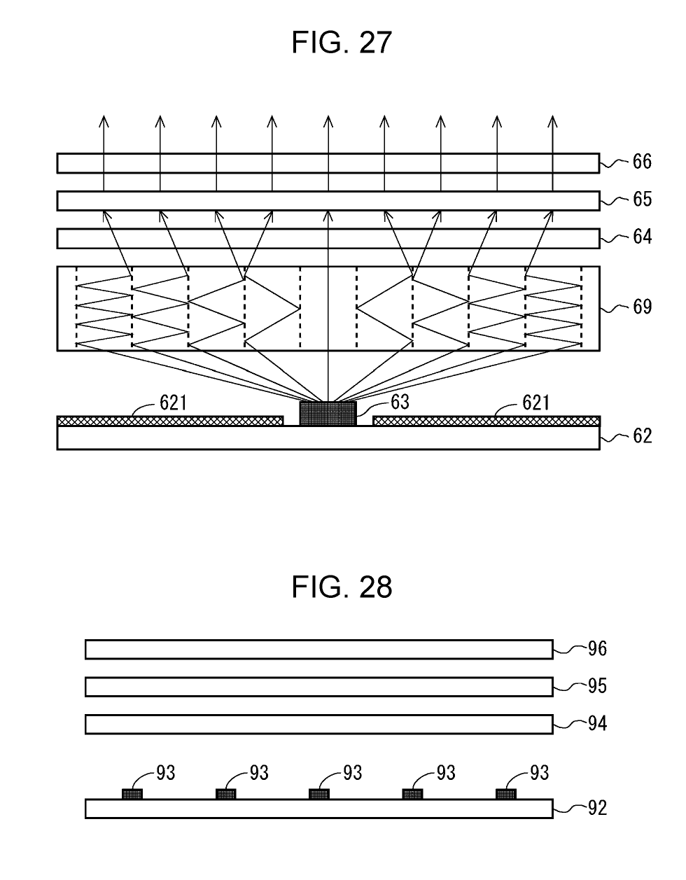

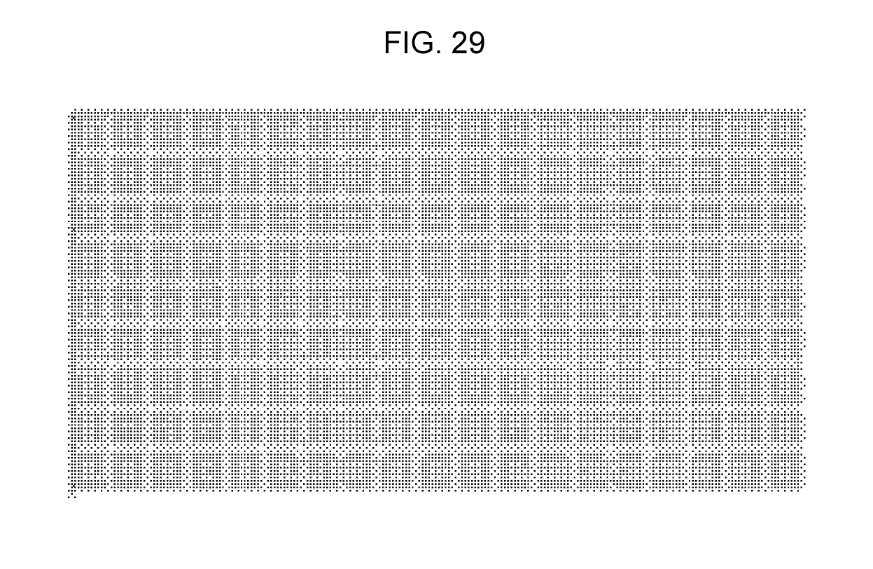

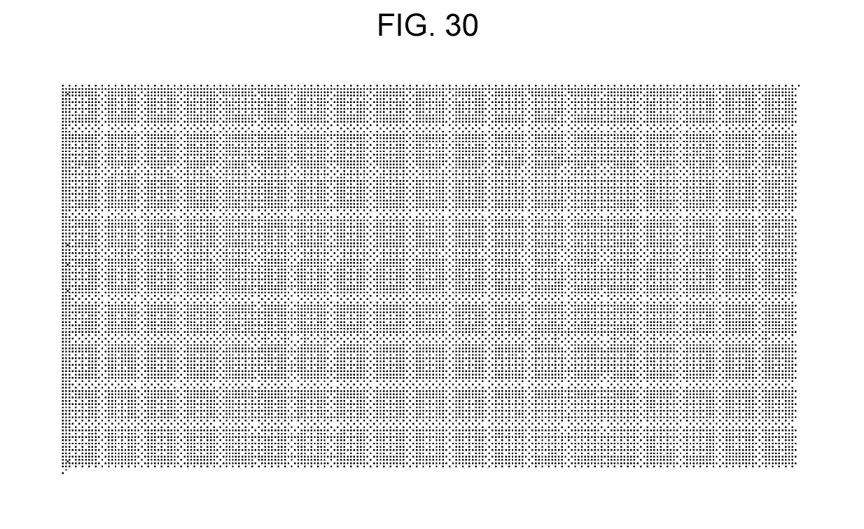

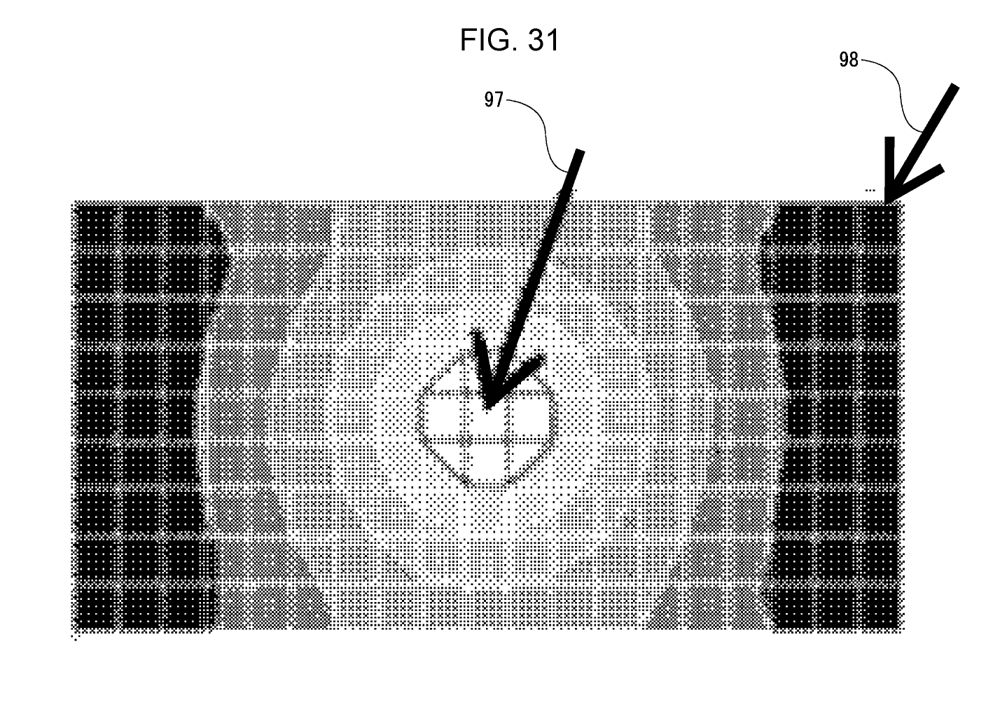

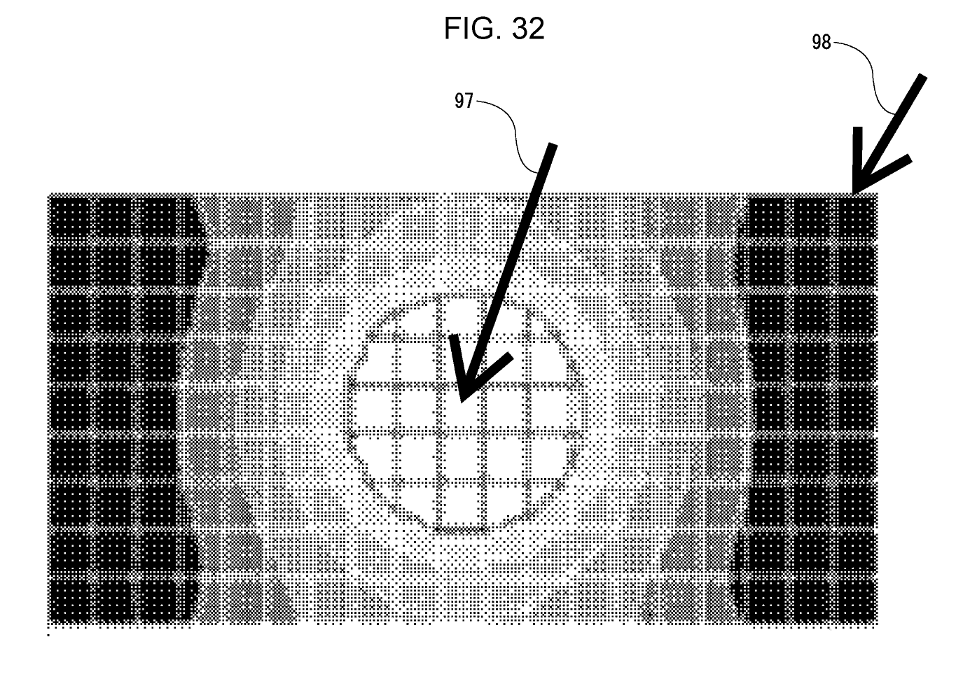

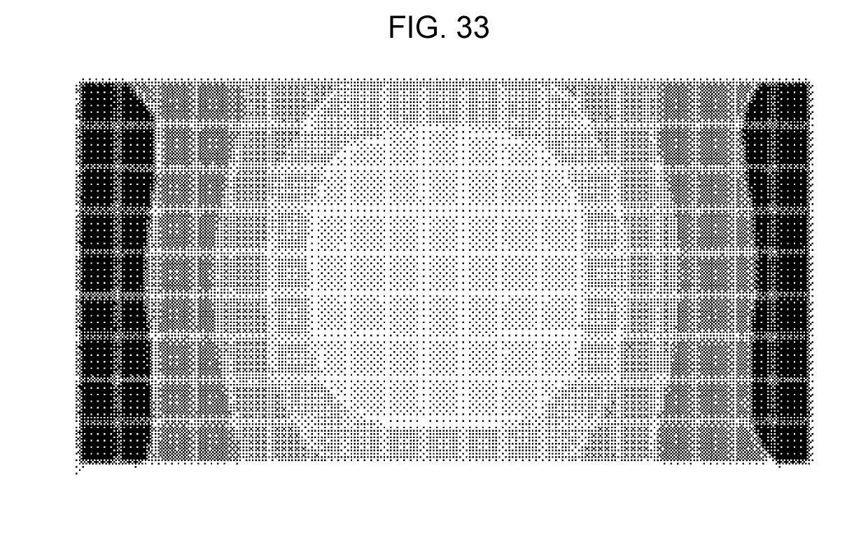

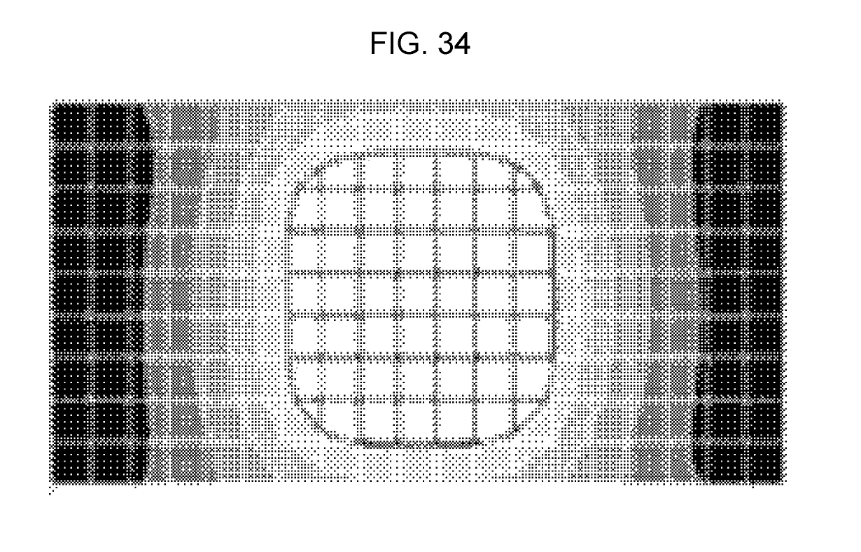

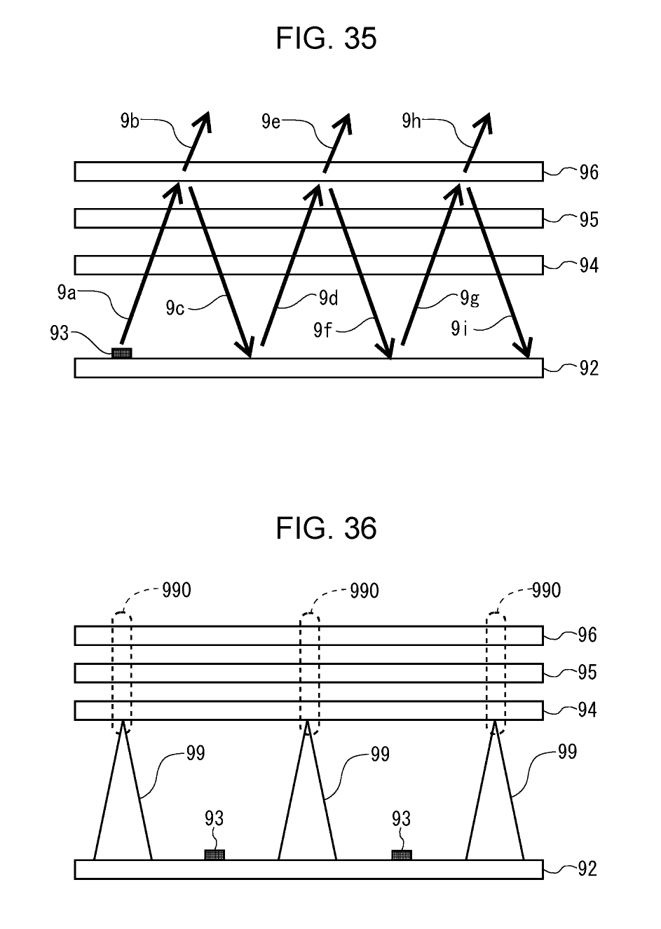

By providing the above-described light guide plate (light guide plate designed so as not to spread light) 69 above the blue LED 63, the light emitted from the blue LED 63 progresses from the LED substrate 62 side to the liquid crystal panel 400 side while repeating the reflection inside the light guide plate 69 as shown in FIG. 27. Therefore, the incident angle of the light emitted from the blue LED 63 on the phosphor sheet 65 is smaller than the one in the related art. Accordingly, it is possible to suppress the light emitted from the blue LED 63 in each area from reaching other areas.

### 3.2 Effect

In the present embodiment, similarly to the first embodiment, in the liquid crystal display apparatus adopting the backlight device 600 having a configuration combining the blue LED 63 and the phosphor sheet 65, the occurrence of color unevenness and collapsing of white balance is suppressed.

### 4. Others

In each of the above-described embodiments (including modification examples), the phosphor sheet 65 is used as a wavelength conversion sheet for obtaining white light from blue light, but the present disclosure is not limited thereto. A quantum dot sheet can also be used in place of the phosphor sheet 65. For example, it is also possible to use a quantum dot sheet including a green quantum dot having an emission peak wavelength of 500 to 550 nm and a red quantum dot having an emission peak wavelength of 600 nm or more. By using such a quantum dot sheet, the half value width of the green light and the red light can be narrowed. Therefore, by combining a backlight device having such a configuration using a quantum dot sheet and a liquid crystal panel having a configuration using a high-density color filter, widening of the color gamut of the liquid crystal display apparatus is realized.

In each of the above-described embodiments, the local dimming processing is performed, but the present disclosure is not limited thereto. The present disclosure can also be applied to a liquid crystal display apparatus not subjected to the local dimming processing.

Furthermore, in each of the above-described embodiments, a liquid crystal display apparatus has been described as an example, but the present disclosure is not limited thereto. The present disclosure can also be applied to a display apparatus other than the liquid crystal display apparatus as long as it is a display apparatus using a direct backlight device.

This application claims priority based on Japanese Patent Application No. 2016-100101, which was entitled “backlight device and display device using same” and filed on May 19, 2016, the contents of which, are incorporated herein by reference, in their entirety.

### REFERENCE SIGNS LIST

61 chassis
62 LED substrate
63 blue LED
64 diffuser plate
65 phosphor sheet
66 optical sheet
67 convex lens
68, 68a, 68b prism sheet
69 light guide plate
400 liquid crystal panel
410 display unit
500 light source control unit
600 backlight device
621 reflection sheet
671 Fresnel lens
675 lens substrate
681 prism
691 reflection material

1. A backlight device of a direct type, comprising:
a light source substrate on which a blue light emitting element that emits blue light is mounted;
a wavelength conversion sheet that converts a wavelength of the light emitted from the blue light emitting element; and
an optical member that is provided on the light source substrate side from the wavelength conversion sheet, receives the light emitted from the blue light emitting element, and emits the light to the wavelength conversion sheet side so that an emission angle is smaller than an incident angle.

2. The backlight device according to claim 1,
wherein the optical member changes a progressing direction of the light emitted from the blue light emitting element in a direction perpendicular to the light source substrate.

3. The backlight device according to claim 1,
wherein the optical member is a condenser lens.

4. The backlight device according to claim 3,
wherein the condenser lens is a convex lens.

5. The backlight device according to claim 3,
wherein the condenser lens is a Fresnel lens.

6. The backlight device according to claim 3,
wherein the optical member has a structure that a plurality of blue light emitting elements and a plurality of condenser lenses are integrated in a one-to-one correspondence.

7. The backlight device according to claim 1,
wherein the optical member is a prism.

8. The backlight device according to claim 1,
wherein the optical member is a prism sheet in which a plurality of prism rows are formed.

9. The backlight device according to claim 8,
wherein as the prism sheet, at least a first prism sheet and a second prism sheet in which a plurality of prism rows orthogonal to a plurality of prism rows formed in the first prism sheet are formed, are provided.

10. The backlight device according to claim 8, further comprising:
a diffuser plate that is provided on the light source substrate side from the wavelength conversion sheet, and diffuses the light emitted from the blue light emitting element,
wherein the prism sheet is provided between the blue light emitting element and the diffuser plate.

11. The backlight device according to claim 8, further comprising:
a diffuser plate that is provided on the light source substrate side from the wavelength conversion sheet, and diffuses the light emitted from the blue light emitting element,
wherein the prism sheet is provided between the diffuser plate and the wavelength conversion sheet.

12. The backlight device according to claim 1,
wherein the optical member is a light guide plate in which reflection materials having surfaces perpendicular to the light source substrate are provided at equal intervals.

13. A display apparatus comprising:
a display panel that includes a display unit which displays an image;
the backlight device according to claim 1 that is disposed so as to irradiate a back surface of the display panel with light; and
a light source control unit that controls light emission intensity of the blue light emitting element.

14. The display apparatus according to claim 13,
wherein the display unit is logically divided into a plurality of areas,
wherein one or a plurality of blue light emitting elements are associated with each area, and
wherein the light source control unit controls the light emission intensity of the blue light emitting element for each area.

15. The display apparatus according to claim 14,
wherein the light emitted from the blue light emitting element associated with each area is applied up to next neighboring area through the optical member.
